(19) United States
(12) Patent Application Publication
(10) Pub. No.: US 2019/0072704 A1
(43) Pub. Date: Mar. 7, 2019

(54) LIGHT-GUIDE PLATE, LIGHTING DEVICE AND DISPLAY DEVICE USING SAME LIGHT-GUIDE PLATE

(71) Applicant: SHARP KABUSHIKI KAISHA, Sakai City, Osaka (JP)

(72) Inventor: KENJI TAKASE, Sakai City (JP)

(21) Appl. No.: 16/093,621

(22) PCT Filed: Apr. 6, 2017
(86) PCT No.: PCT/JP2017/014355

§ 371 Date: Oct. 13, 2018

(30) Foreign Application Priority Data
Apr. 13, 2016 (JP) 2016-080492

(51) Int. Cl. F21V 8/00; G02F 1/1333; G02F 1/1335

(52) U.S. Cl. CPC G02B 6/004; G02B 6/0065; G02F 1/133603; G02B 6/0093; G02F 1/133308; G02B 6/0055

(57) ABSTRACT

The present invention achieves a light-guide plate with less uneven light emission. The light-guide plate includes a front surface and a back surface, which are surfaces different from an end face of light incident surface and face each other. A dot pattern including a main dot and a sub-dot having different shapes from each other is disposed on the back surface.

### TECHNICAL FIELD

The present invention relates to a light-guide plate, a lighting device using the light-guide plate, and a display device using the light-guide plate.

### BACKGROUND ART

In recent years, a liquid crystal display device of which opposite side may be seen through has been developed, which is called a transparent display, a see-through display or the like. For example, PTLs 1 and 2 disclose a transparent display and propose to use a transparent display as a lighting device, a light shielding device, and a partition plate. A lighting device including a light-guide plate is used for such a transparent display.

PTLs 1, 2, 3, and 4 disclose a light-guide plate in which concave dots having the same shape are disposed on one or both main surfaces. The light-guide plate emits light incident from an end face in a planar shape from the other or both main surfaces by the dots.

### CITATION LIST

### Patent Literature

PTL 1: Japanese Unexamined Patent Application Publication No. 2011-119135 (published on Jun. 16, 2011)

PTL 2: Japanese Unexamined Patent Application Publication No. 2013-77570 (published on Apr. 25, 2013)

PTL 3: Japanese Unexamined Patent Application Publication No. 2007-80789 (published on Mar. 29, 2007)

PTL 4: International Publication No. 2014-097662A1 (published on Jun. 26, 2014)

### SUMMARY OF INVENTION

### Technical Problem

However, in the light-guide plate of the related art, as described above, although concave dots having the same shape are disposed on one or both main surfaces, the function of diffusing light inside a light guide is not sufficient. For this reason, there is a problem that uneven light emission is likely to occur from the light-guide plate on which concave dots having the same shape are disposed. As a result, it was necessary to provide a diffusing optical sheet on the main surface of the light-guide plate of the related art.

The present invention has been made in view of the above problem, and an object thereof is to provide a light guide plate in which light diffusion and uneven light emission are sufficiently reduced even without the diffusing optical sheet.

### Solution to Problem

In order to solve the above problem, the light-guide plate according to one aspect of the present invention includes a first main surface and a second main surface, in which the first main surface and the second main surface are surfaces different from an end face of light incident surface and face each other, and a dot pattern including a first type dot and a second type dot which are structures having different shapes from each other is disposed on the second main surface.

According to the above configuration, the dot pattern includes the first type dot and the second type dot which are structures having different shapes from each other. For this reason, the reflection and refraction by the dot pattern become complicated as compared with the reflection and refraction by a dot pattern in which a dot having one kind of shape is disposed, and since the light is sufficiently diffused in the light guide, uneven light emission of the light-guide plate is reduced.

Therefore, even if there is no diffusing optical sheet disposed on the main surfaces of the light-guide plate having a dot pattern in which a dot having one kind of shape in the related art is disposed, it is possible to provide a light-guide plate in which light diffusion and uneven light emission are sufficiently reduced.

### Advantageous Effects of Invention

According to one embodiment of the present invention, an effect of reducing the uneven light emission of the light-guide plate is obtained.

### BRIEF DESCRIPTION OF DRAWINGS

FIG. 1 is a diagram showing a lighting device using a light-guide plate according to Embodiment 1 of the present invention.

FIG. 2 is a diagram for describing a light path to the light-guide plate in the lighting device shown in FIG. 1.

FIG. 3 is a diagram for describing main dots and sub-dots formed in the light-guide plate shown in FIG. 1.

FIG. 4 is a diagram for describing a light path to a light-guide plate in a lighting device using the light-guide plate according to Embodiment 2 of the present invention.

FIG. 5 is a diagram for describing a dot pattern in a lighting device using a light-guide plate according to Embodiment 3 of the present invention.

FIG. 6 is a diagram for describing a light-guide plate according to Embodiment 4 of the present invention.

FIG. 7 is a diagram showing the alignment angle characteristics of a lighting device using the light-guide plate shown in FIG. 6.

FIG. 8 is a diagram for describing a light path to a light-guide plate 5 in a lighting device using the light-guide plate according to Embodiment 5 of the present invention.

FIG. 9 is a diagram for describing a light flux emitted from a front surface and a light flux emitted from a rear surface in a lighting device using a light-guide plate according to Embodiment 6 of the present invention.

FIG. 10 is a diagram for describing a light flux emitted from a front surface and a light flux emitted from a rear surface in a lighting device using a light-guide plate according to Embodiment 7 of the present invention.

FIG. 11 is a perspective diagram showing a schematic configuration of a lighting equipment using a light-guide plate according to Embodiment 8 of the present invention.

FIG. 12 is a partial cross-sectional diagram showing a liquid crystal display device using a light-guide plate according to Embodiment 9 of the present invention.

FIG. 13 is a partial cross-sectional diagram showing a liquid crystal display device using a light-guide plate according to Embodiment 10 of the present invention.

FIG. 14 is a partial cross-sectional diagram showing a liquid crystal display device using a light-guide plate according to Embodiment 11 of the present invention.

### DESCRIPTION OF EMBODIMENTS

### Embodiment 1

(Lighting Device)

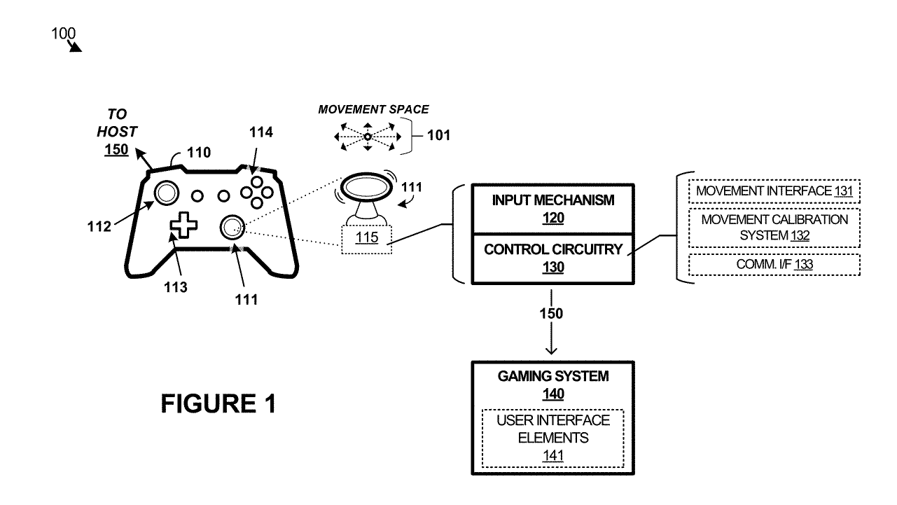

Hereinafter, Embodiment 1 of the present invention will be described in detail with reference to FIGS. 1 to 3.

FIG. 1 is a diagram showing a lighting device 41 using a light-guide plate 1 according to Embodiment 1 of the present invention. (a) of FIG. 1 is a top diagram of a lighting device 41 in which a front chassis 11 and a bezel 14 of a housing 10 are omitted, and (b) of FIG. 1 is a partial cross-sectional diagram of the lighting device 41 and is a cross-sectional diagram taken along a line A-A in (a) of FIG. 1.

The lighting device 41 shown in FIG. 1 represents an example of a configuration when the light-guide plate 1 is used as a backlight of a display device. By disposing a liquid crystal panel above the lighting device 41, the lighting device 41 may be used as a backlight.

As shown in FIG. 1, the lighting device 41 includes a light emitting source 15 (light source) including a light emitting device (LED) substrate 16 and LEDs 17 mounted on the LED substrate 16, a light-guide plate 1, a protection cover 31 for protecting the light-guide plate 1, a reflection sheet 32 for reflecting light leaking from the light-guide plate 1, a control circuit (not shown) for driving and controlling the light emitting source 15, and the like in a housing 10 including a front chassis 11, a rear chassis 12, and a bezel 14.

As the housing 10, the protection cover 31, the reflection sheet 32, and the control circuit, known ones may be used and will not be described in detail in this specification.

The light emitting source 15 is disposed to face an end face 21 of the light-guide plate 1 as a light incident surface while being spaced apart from each other. In other words, the light emitting source 15 is disposed at the end of the rear chassis 12 so that she light emitted from the light emitting source 15 is incident on the end face 21 of the light-guide plate 1. In the present embodiment, the light emitting source 15 is assumed to be a line light source having LEDs 17 arranged in a line, but the configuration of the light emitting source 15 is not limited thereto. As the light emitting source 15, only one LED 17 which is a point light source may be disposed, and a fluorescent lamp or the like which is a line light source may be used. In addition, the light emitting source 15 may be disposed so that light is incident on the plurality of end faces 21 of the light-guide plate 1.

The reflection sheet 32 is disposed between the rear chassis 12 and a rear surface 23 (second main surface) of the light-guide plate 1 so as to face the rear surface 23 of the light-guide plate 1 with an air layer interposed therebetween. In other words, the reflection sheet 32 is disposed to be separated from the rear surface 23 of the light-guide plate 1. The reflection sheet 32 reflects light outgoing from the rear surface 23 of the light-guide plate 1.

The protection cover 31 is disposed to face a front surface 22 (first main surface) of the light-guide plate 1 with an air layer interposed therebetween. The protection cover 31 protects the surface of the light-guide plate 1 that is not protected by the housing 10. The protection cover 31 is made of a transparent resin material. No optical sheet such as a lens sheet or a diffusing sheet is disposed between the protection cover 31 and the front surface 22 of the light-guide plate 1.

The reflection sheet 32, the light-guide plate 1, and the protection cover 31 are disposed in this order so as to overlap inside the rear chassis 12 and are fixed by the front chassis 11 and the bezel 14.

The light-guide plate 1 emits the light emitted from the light emitting source 15 and incident from the end face 21, from the front surface 22 which is a light outgoing surface. In the present embodiment, it is assumed that the light-guide plate 1 is formed of a material such as polymethyl methacrylate (PMMA) having a refractive index of 1.49 or glass having a refractive index of 1.49, but the light-guide plate 1 may be formed of other materials.

In a case where the lighting device 41 is used as a backlight for a transparent display, the reflection sheet 32 disposed on the rear surface 23 side of the light-guide plate 1 may be replaced with a transparent protection member and the rear chassis 12 in the region corresponding to the rear surface 23 of the light-guide plate 1 may be removed (see FIG. 13). The same applies to each lighting device described in Embodiment 2 and the following.

In this way, it is possible to obtain the lighting device 41 in which the region surrounded by the housing 10 is transparent. In particular, in a case where the lighting device 41 is used as a backlight of a transparent display or the like, it is necessary to lower a haze ratio of the light-guide plate 1 to ensure transparency.

(Light-Guide Plate)

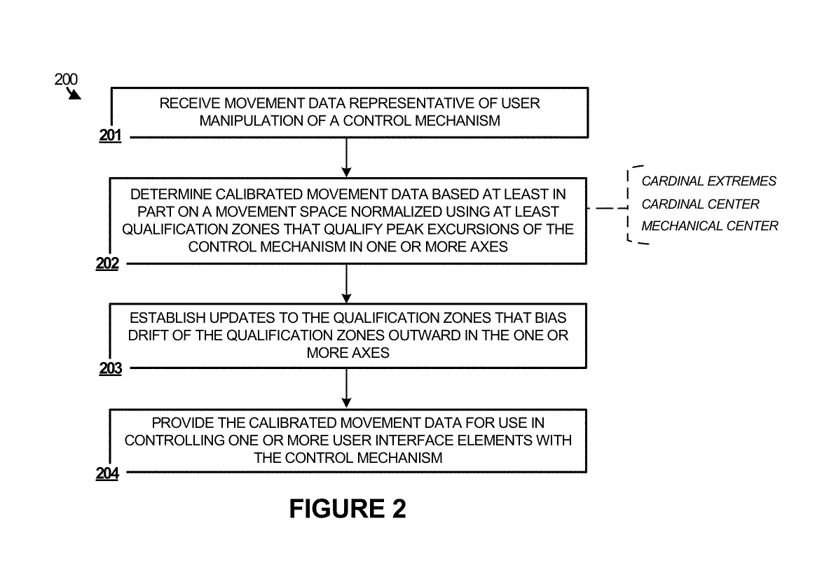

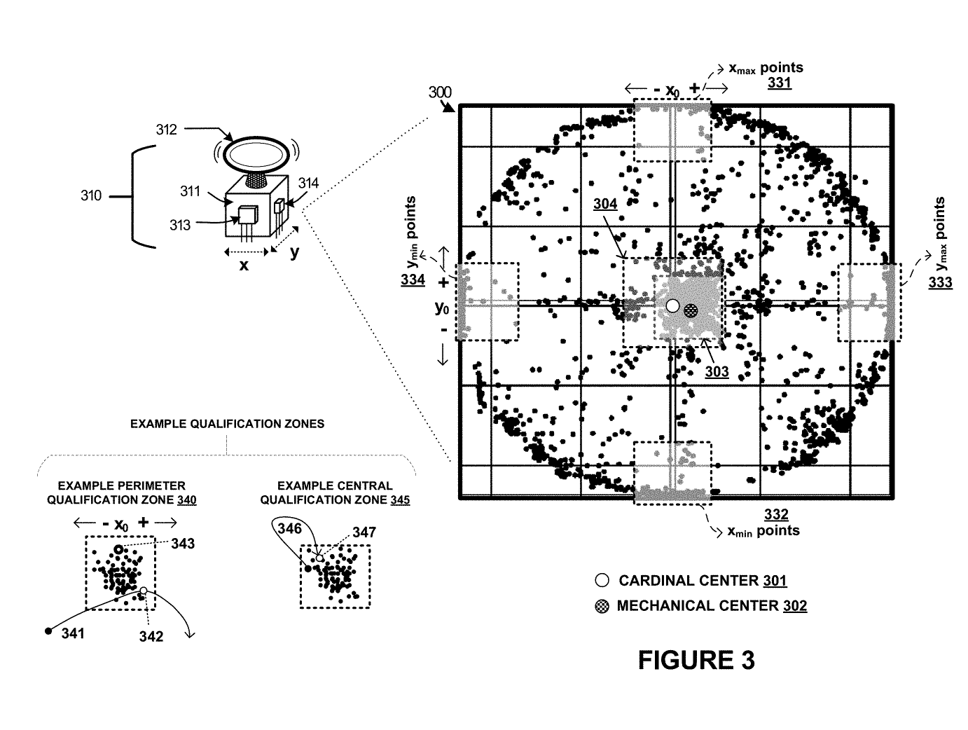

FIG. 2 is a diagram for describing a light path to the light-guide plate 1 in the lighting device 41 shown in FIG. 1. FIG. 3 is a diagram for describing main dots 24 (first type dots) and sub-dots 25 (second type dots) formed in the light-guide plate 1 shown in FIG. 1. For simplicity, the lighting device 41 in FIG. 2 shows only the light emitting source 15 and the light-guide plate 1. In FIGS. 2 and 3, in order to distinguish between the main dots 24 and the sub-dots 25, the outline of the sub-dots 25 is indicated by a bold line.

As shown in FIG. 2, a dot pattern 26 composed of the main dots 24 and the sub-dots 25 is disposed on the rear surface 23 of the light-guide plate 1. The main dots 24 and the sub-dots 25 are formed in a convex shape protruding from the surface of the rear surface 23 of the light-guide plate 1. The main dots 24 and the sub-dots 25 are structures having different shapes from each other. The light incident from the end face 21 of the light-guide plate 1 travels while being reflected and refracted by the main dots 24 and the sub-dots 25 and is emitted from the front surface 22 of the light-guide plate 1.

As shown in FIG. 1, in plan view, the light outgoing direction of the light emitting source 15 is defined as an optical axis direction 18, and a direction perpendicular to the optical axis direction is defined as a normal direction 19.

In the dot pattern 26, the main dots 24 and the sub-dots 25 are disposed periodically, that is, regularly so that the centers of the main dots 24 and the centers of the sub-dots 25 are disposed on a line extending in the optical axis direction 18 when light enters the end face 21 and on a line extending in the normal direction 19 orthogonal to the optical axis direction 18. In other words, the main dots 24 and the sub-dots 25 are disposed so that the centers of the main dots 24 and the sub-dots 25 coincide with the intersections of the grid formed by the line extending in the optical axis direction 18 and the line extending in the normal direction 19.

In addition, the main dots 24 and the sub-dots 25 are disposed such that as the distances thereof from the light emitting source 15 increase exponentially, the interval thereof becomes narrow so that the intensity distribution of the light emitted on the front surface 22 becomes uniform. The sub-dots 25 occupies 1% or more and less than 50% of the entire dot pattern 26 and are distributed non-cyclically, that is, irregularly (non-periodically) with respect to the dot pattern 26.

As shown in (a) and (c) of FIG. 3, the shape of the main dot 24 is a truncated cone with the angle (taper angle) of θ₁ formed by the lower bottom surface and the inclined side surface, the upper bottom surface parallel to the lower bottom surface, and the area of the upper bottom surface smaller than the lower bottom surface. As shown in (b) and (c) of FIG. 3, the shape of the sub-dots 25 is a truncated cone with a taper angle of θ₂, the upper bottom surface parallel to the lower bottom surface, and the area of the upper bottom surface smaller than the lower bottom surface. The main dot 24 and the sub-dot 25 are different from each other at the taper angles θ₁ and θ₂, for example, θ₁<θ₂. Since θ₁≠θ₂, reflection and refraction by the dot pattern 26 including the main dots 24 and the sub-dots 25 are complicated and light traveling in the light-guide plate 1 is sufficiently diffused, it is possible to reduce the uneven light emission of the light-guide plate 1. Further, since the sub-dots 25 are non-periodically distributed with respect to the dot pattern 26, reflection and refraction by the entire dot pattern 26 are random, and it is possible to further reduce the uneven light emission of the light-guide plate.

In the light-guide plate of the related art, since only one type of dot shape is used, light incident on the light guide may not be sufficiently reflected or refracted, and light scattering in the light-guide plate was not sufficient. Further, in a case where the disposition of the entire dot pattern composed of such dots of the same shape is regular, reflection and refraction by the entire dot pattern are also simple and regular. For this reason, in the light-guide plate of the related art, there was a problem that the dot pattern is easy to visually recognize and uneven light emission tends to occur on the light outgoing surface. Therefore, it is necessary to provide a diffusing sheet (optical sheet for diffusion) for sufficiently diffusing light and reducing uneven light emission. On the other hand, in the light-guide plate 1 according to Embodiment 1 of the present invention, since the dot pattern 26 includes at least two kinds of dots which are structures having different shapes of the main dot 24 and the sub-dot 25, reflection and refraction by the entire dot pattern 26 becomes complicated, the dot pattern 26 is hard to be visually recognized on both of the front surface 22 and the rear surface 23, and uneven light emission hardly occurs. Therefore, a diffusing sheet for reducing the uneven light emission is unnecessary. In this way, it is possible to make the lighting device 41 thinner, lighter, and transparent, and improve illumination efficiency, and the like. In particular, in a case where the lighting device 41 is used as a backlight of a transparent display, it is important to make the image display portion of the lighting device 41 transparent.

The shapes of the main dot 24 and the sub-dot 25 may be another pyramid such as a truncated square cone, a cone body, or a cone such as a square cone. For example, as shown in (d) of FIG. 3, the sub-dot 25 may be a truncated square cone with a taper angle of θ₂, an upper bottom surface parallel to the lower bottom surface, and the area of the upper bottom surface smaller than the lower bottom surface.

It is preferable that the sub-dots 25 are distributed so as to be mixed in the main dots 24 in order to reduce moire. Specifically, it is preferable that adjacent dots in the optical axis direction 18 and the normal direction 19 with respect to an arbitrary sub-dot 25 are not the sub-dots 25 but the main dots 24.

In addition, it is preferable that the shapes of the main dots 24 and the sub-dots 25 are a truncated cone or a cone body so as not to function as a diffraction grid in order to reduce uneven light emission and moire. In addition, in a case where the shapes of the main dots 24 and the sub-dots 25 are truncated square cones or square cones in order to increase the luminance when viewed from a direction orthogonal to the front surface 22 of the light-guide plate 1, it is also preferable chat the main dots 24 and the sub-dots 25 are disposed so that the side faces of the truncated square cone or square cone faces the end face 21 of the light-guide place 1.

In addition, as shown in FIG. 2, the light orthogonal to the rear surface 23 of the light-guide plate 1 is refracted when transmitting through the light-guide plate 1 through the inclined side surface and is not refracted when transmitting through the light-guide plate 1 through the upper bottom surface. Therefore, the haze ratio of the light-guide plate 1 decreases as the proportion of the inclined side faces of the main dots 24 and the sub-dots 25 occupying the front surface 22 of the light-guide plate 1 is smaller when viewed from a direction orthogonal to the front surface 22. Therefore, in order to reduce the haze ratio of the light-guide plate 1, it is preferable that the shapes of the main dot 24 and the sub-dot 25 are a pyramid with the upper bottom surface parallel to the lower bottom surface. In this way, it is possible to obtain a more transparent light-guide plate 1.

The main dot 24 and the sub-dot 25 may also have different taper angles θ₁, θ₂, and θ₁≠θ₂. However, in order to suppress the haze ratio of the light-guide plate 1, it is preferable that θ₁<θ₂ so that the proportion of the inclined side faces of the main dot 24 and the sub-dot 25 occupying the front surface 22 of the light-guide plate 1 decreases when viewed from a direction orthogonal to the front surface 22. This is because the taper angle θ₁ of the main dot 24 which mainly constitutes the dot pattern 26 is determined according to a desired optical performance of the light-guide plate 1 and the taper angle θ₂ of the sub-dot 25 is determined to be different from the taper angle θ₁ of the main dot 24.

In addition, in the dot pattern 26, projections protruding from the rear surface 23 of the light-guide plate 1 are provided in a dot shape. Therefore, the light-guide plate 1 according to the present embodiment may achieve higher luminance and lower haze as compared to a light-guide plate in which a dot pattern with a scattering agent for scattering light coated in a dot shape is disposed.

### Embodiment 2

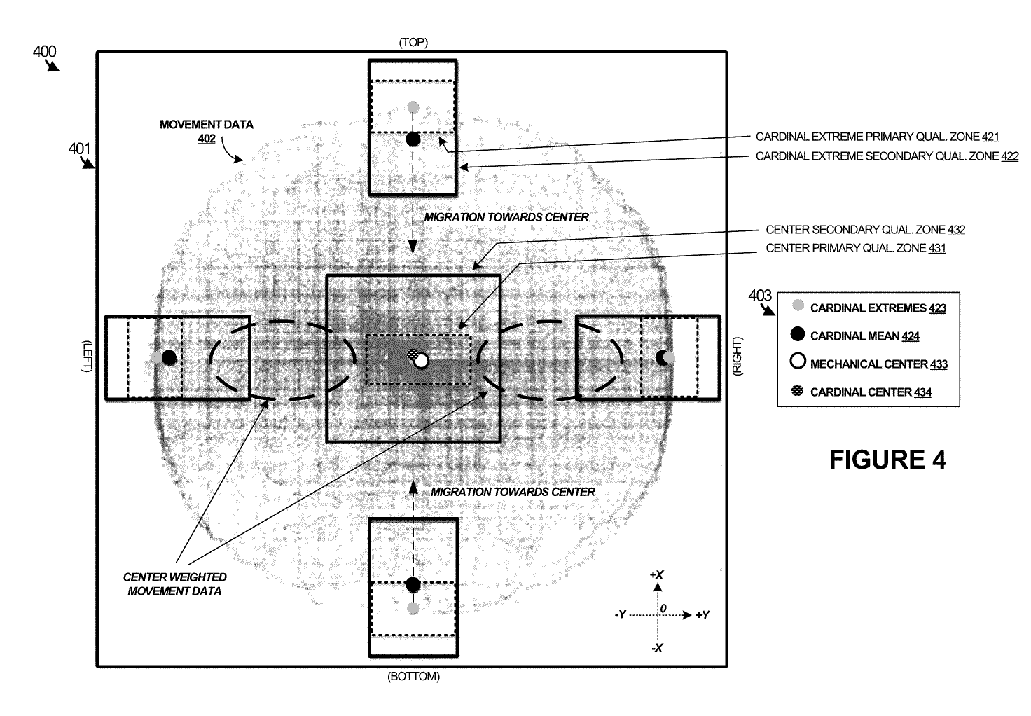

Another embodiment of the present invention will be described with reference to FIG. 4 as follows. For the convenience of explanation, members having the same functions as those described in the above embodiment are denoted by the same reference numerals, and description thereof is omitted.

FIG. 4 is a diagram for describing a light path to a light-guide plate 2 in a lighting device 42 using the light-guide plate 2 according to Embodiment 2. For simplicity, the lighting device 42 in FIG. 4 shows only the light emitting source 15 and the light-guide plate 2. That is, like the lighting device 41 (see FIG. 2) according to Embodiment 1 described above, the lighting device 42 includes the light emitting source 15, the light-guide plate 2, the protection cover 31 that protects the light-guide plate 2, the reflection sheet 32 that reflects light leaking from the light-guide plate 2, a control circuit, and the like in the housing 10.

The lighting device 42 is different from the lighting device 41 only in that the dot pattern 26 is recessed concavely from the surface of the rear surface 23 of the light-guide plate 2.

The light-guide plate 2 is similar to the light-guide plate 1 in that the dot pattern 26 is disposed at the intersections of the grid formed by the line extending in the optical axis direction 18 and the line extending in the normal direction 19.

As shown in FIG. 4, on the rear surface 23 of the light-guide plate 2, the dot pattern 26 composed of the main dots 24 and the sub-dots 25 is disposed to be recessed from the surface of the rear surface 23.

In the light-guide plate 2, since the dot pattern 26 has a concave shape, light traveling through the light-guide plate 2 more easily strikes the side surface of the main dots 24 and the side surface of the sub-dots 25, as compared with the light-guide plate 1 in which the dot pattern 26 is disposed in a convex shape. Therefore, the expected value of the number of times the light is reflected and refracted by the main dots 24 and the sub-dots 25 increases from the incidence from the end face 21 to the emission from the front surface 22, and the luminance as viewed from a direction orthogonal to the front surface 22 of the light-guide plate 2 increases.

Further, since light easily strikes the side surfaces of the main dots 24 and the sub-dots 25 in the light-guide plate 2 by making the dot pattern 26 recessed from the surface of the rear surface 23 as compared with the case where the shape of the dot pattern 26 protrudes from the surface of the rear surface 23, it is possible to suppress the light incident on the light-guide plate 2 from the end face of the light-guide plate 2 from being emitted to the outside of the light-guide plate 2 through the end face on the opposite side to the end face 21 of the light-guide plate 2. From this point as well, it is possible to improve the luminance of the front surface 22 of the light-guide plate 2.

In addition, since the dot pattern 26 is disposed in a recessed manner, the thickness of the light-guide plate 1 does not increase from a thickness h of the main portion due to the height of the main dots 24 or the height of the sub-dots 25. Therefore, the thickness of the light-guide plate 2 is reduced. That is, it is possible to provide a thinner light-guide plate.

In addition, since the dot pattern 26 is disposed in a concave shape, the surface of the rear surface 23 may be flattened. Therefore, since the main dots 24 and the sub-dots 25 are not scraped off by friction or rubbing, it is possible to handle the light-guide plate 2 easily as compared with the light-guide plate 1.

### Embodiment 3

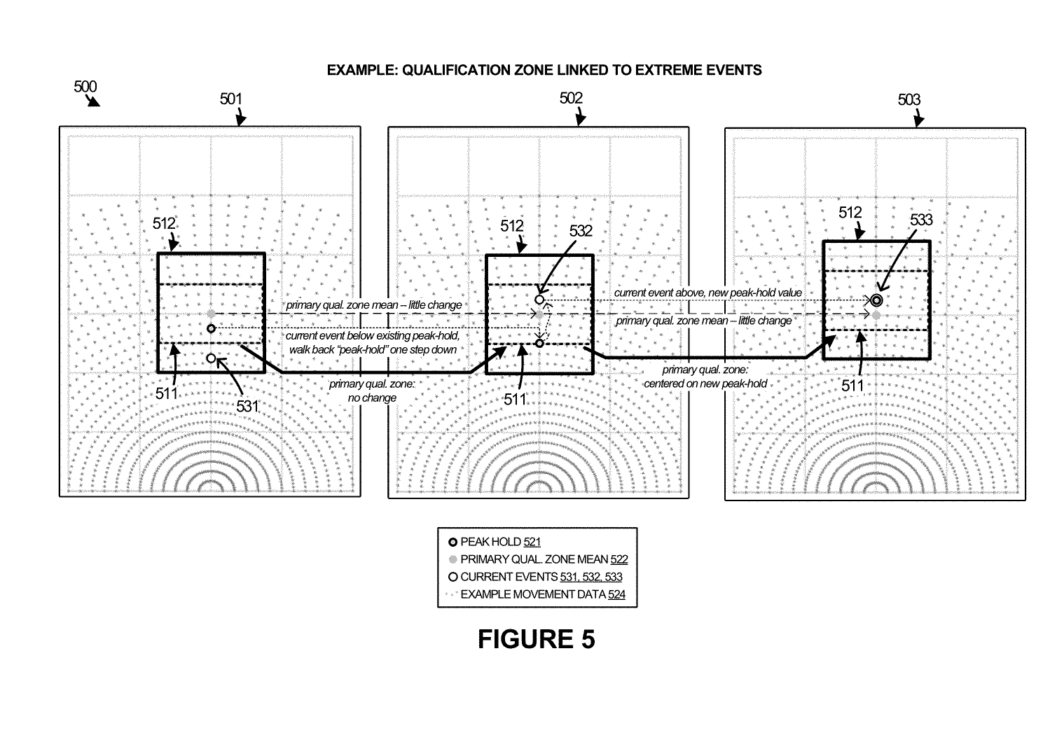

Another embodiment of the present invention will be described with reference to FIG. 5 as follows. For the convenience of explanation, members having the same functions as those described in the above embodiment are denoted by the same reference numerals, and description thereof is omitted.

FIG. 5 is a diagram for describing a dot pattern 27 in a lighting device 43 using a light-guide plate 3 according to Embodiment 3 of the present invention (a) of FIG. 5 shows a regular dot pattern 26 according to the above-described Embodiment 2, and (b) of FIG. 5 shows a random dot pattern 27 according to Embodiment 3. For simplicity, the housing 10 is omitted in FIG. 5. That is, like the lighting devices 41 and 42 according to Embodiments 1 and 2 described above, the lighting device 43 according to Embodiment 3 includes the light emitting source 15, the light-guide plate 3, the protection cover 31 that protects the light-guide plate 3, the reflection sheet 32 that reflects light leaking from the light-guide plate 3, a control circuit, and the like in the housing 10.

The lighting device 43 according to Embodiment 3 is different from the lighting device 42 according to Embodiment 2 described above only in that the disposition of the dot pattern 27 that is recessed from the surface of the rear surface 23 of the light-guide plate 3 is random.

As shown in (a) of FIG. 5, the lighting device 42 according to Embodiment 2 has a regularly disposed dot pattern 26, the centers of the main dots 24 and the sub-dots 25 are positioned at intersections or the grid formed by the line extending in the optical axis direction 18 and the line extending in the normal direction 19.

On the other hand, as shown in (b) of FIG. 5, the dot pattern 27 disposed on the rear surface 23 of the light-guide plate 3 included in the lighting device 43 according to Embodiment 3 is deviated from the centers of the main dots 24 and the sub-dots 25 from the intersections of the grid formed by the line extending in the optical axis direction 18 and the line extending in the normal direction 19.

As described above, in the non-periodically disposed dot patterns 27, the line segment connecting the centers of two mutually adjacent main dots 24 in the optical axis direction 18 or the normal direction 19, the center of the two sub-dots 25, or the center between one main dot 24 and one sub-dot 25 is inclined with respect to the optical axis direction 18 and the normal direction 19 within the rear surface 23.

Reflection and refraction by such the entire random dot pattern 27 are random even if there is only one type of dot shape. Therefore, the random dot pattern 27 including the two types of main dots 24 and the sub-dots 25 of different shapes may reduce the uneven light emission on the front surface 22 and the rear surface 23 more than the regular dot pattern 26. Therefore, in a case where the lighting device 43 is used as a backlight of a display device, it is possible to suppress the occurrence of moire without using a diffusing sheet or the like.

In addition, in a case where the lighting device 42 is used as a backlight of a transparent display, it is possible to suppress the moire of the display image viewed from the front surface 22 side by disposing a diffusing sheet on the front surface 22 of the light-guide plate 2, and in the case of viewing the display image from the rear surface 23 side, there are cases where uneven light emission and moire due to the regular disposition of the dot pattern 26 are visible.

On the other hand, according to the light-guide plate 3 according to the present embodiment, since the disposition of the dot pattern 27 is random, uneven light emission does not occur on the rear surface 23 of the light-guide plate 3. Therefore, in a case where the lighting device 43 is used as a backlight of a transparent display, even if the display image is viewed from the rear surface 23 side, the uneven light emission and moire are not visually recognized. Therefore, the lighting device 43 using the light-guide plate 3 may also be suitably used as a lighting device for a transparent display.

### Embodiment 4

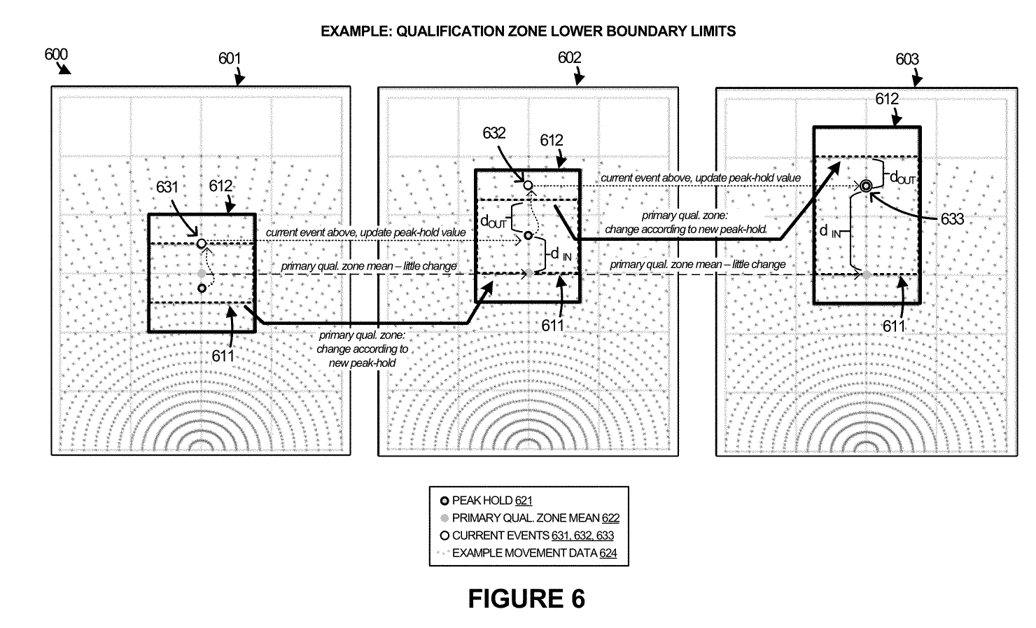

Another embodiment of the present invention will be described with reference to FIG. 6 as follows. For the convenience of explanation, members having the same functions as those described in the above embodiment are denoted by the same reference numerals, and description thereof is omitted.

FIG. 6 is a diagram for describing a light-guide plate 4 according to Embodiment 4 of the present invention of FIG. 6 is a top diagram of the light-guide plate 3 according to Embodiment 3 and the light-guide plate 4 according to Embodiment 4 described above, and (b) of FIG. 6 is a cross-sectional diagram of the light-guide plate 3 according to Embodiment 3 described above, and (c) of FIG. 6 is a cross-sectional diagram of the light-guide plate 4 according to Embodiment 4.

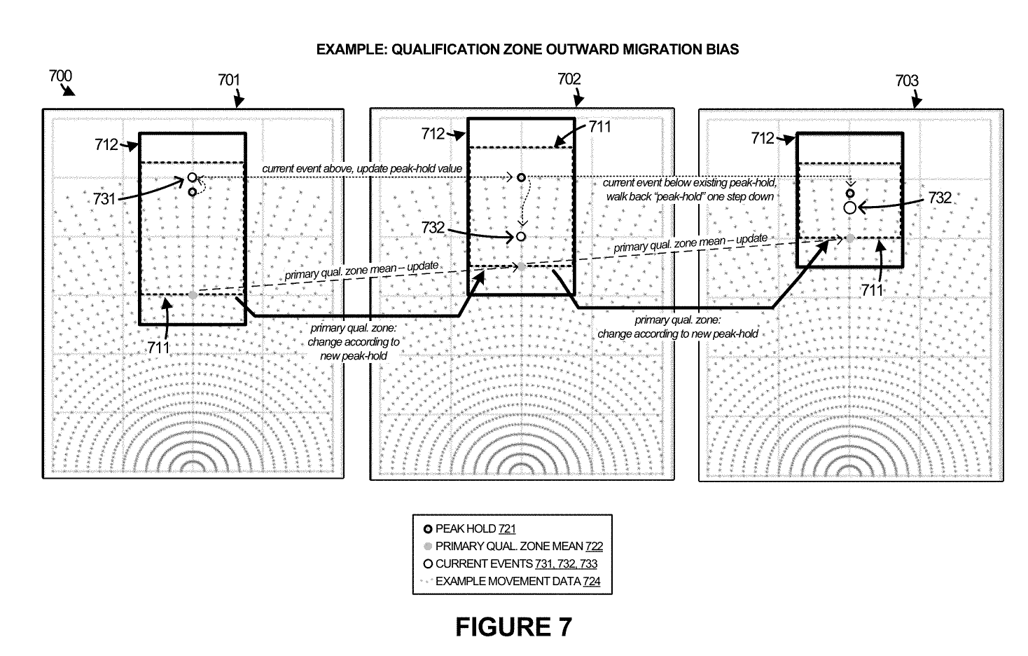

FIG. 7 is a diagram showing the alignment angle characteristics of a lighting device 44 using the light-guide plate 4 shown in FIG. 6. In FIG. 7, the upper side graph shows an alignment angle characteristic g1 of the surface luminance of the front surface 22, the lower side graph shows an alignment angle characteristic g2 of the surface luminance of the rear surface 23, the horizontal axis shows the alignment angle, and the vertical axis shows the surface luminance (nit). For simplicity, the lighting device 44 in FIG. 7 shows only the light emitting source 15 and the light-guide plate 4.

Like the lighting devices 41 to 43 according to Embodiments 1 to 3 described above, the lighting device 42 according to Embodiment 2 includes the light emitting source 15, the light-guide plate 4, the protection cover 31 that protects the light-guide plate 4, the reflection sheet 32 that reflects light leaking from the light-guide plate 4, a control circuit, and the like in the housing 10.

The lighting device 44 according to Embodiment 4 is different from the lighting device 43 according to Embodiment 3 described above only in that toe dot patterns 27 are disposed in a recessed manner on both surfaces of the front surface 22 and the rear surface 23 of the light-guide plate 4.

As shown in FIG. 6, in the light-guide plate 4, the random dot patterns 27 are disposed on both surfaces of the front surface 22 and the rear surface 23 so as to be recessed concavely. As described above, since the same dot patterns 27 are disposed on both sides, as shown in FIG. 7, the alignment angle characteristics g1 and g2 on the front surface and the rear surface 23 are also equal. Therefore, the luminance, brightness distribution, and alignment angle characteristics of the front surface 22 and the rear surface 23 of the light-guide plate 4 may be made equal by providing the dot patterns 27 on both the front surface 22 and the rear surface 23.

Therefore, in a case where the lighting device using the light-guide plate 4 is used as a backlight for a transparent display, it is possible to obtain a transparent display whose luminance is bright not only when viewed from the front surface 22 side but also when viewed from the rear surface 23 side.

Further, the dot pattern 27 is disposed plane-symmetrically on the front surface 22 and the rear surface 23 so that the front surface 22 and the rear surface 23 are plane-symmetrical. Therefore, when viewed from a direction orthogonal to the front surface 22, the dot pattern 27 disposed on the front surface 22 and the dot pattern 27 disposed on the rear surface 23 coincide and overlap. The proportion of the inclined side faces of the main dots 24 and the sub-dots 25 occupying the front surface 22 of the light-guide plates 3 and 4 when viewed from a direction orthogonal to the front surface 22 is the same in the light-guide plate in which the dot pattern 27 is disposed only in the front surface 22 and the light-guide plate 4 in which the dot pattern 27 is disposed on both surfaces of the front surface 22 and the rear surface 23. Therefore, the haze ratio of the light-guide plate 4 according to the present embodiment is equivalent to the haze ratio of the light-guide plate according to the embodiment described above. In other words, even with the light-guide plate 4, it is possible to secure the transparency equivalent to that of the light-guide plate 3.

### Embodiment 5

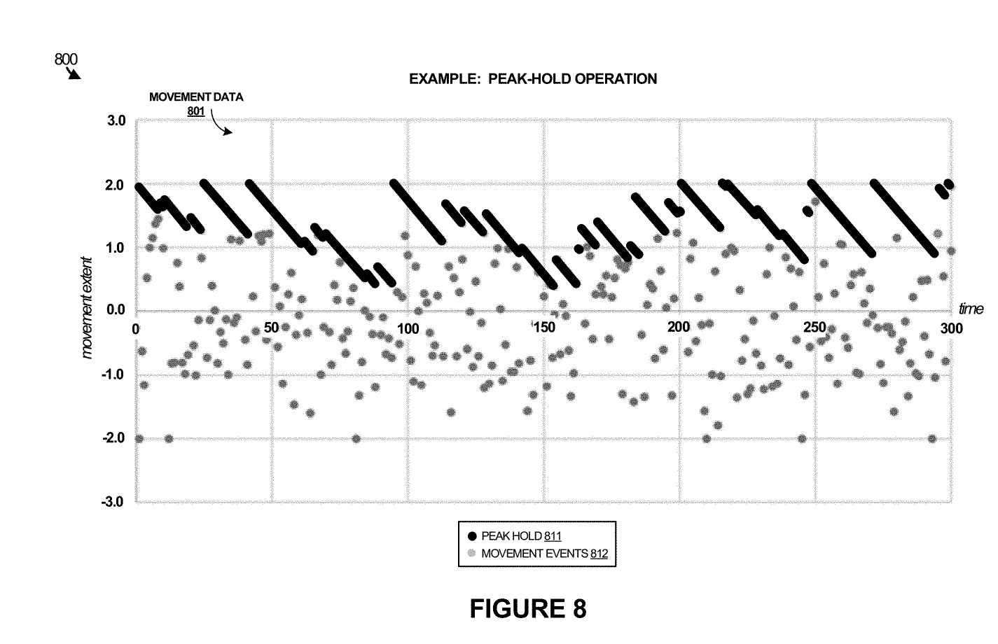

Another embodiment of the present invention will be described with reference to FIG. 8 as follows. For the convenience of explanation, members having the same functions as those described in the above embodiment are denoted by the same reference numerals, and description thereof is omitted.

FIG. 8 is a diagram for describing a light path to a light-guide plate 5 in a lighting device 45 using the light-guide plate 5 according to Embodiment 5. (a) of FIG. 8 shows the light-guide plate 4 using a standard material, and (b) of FIG. 8 shows the light-guide plate 5 using a high-refractive-index material. For simplicity, the lighting devices 44 and 45 in FIG. 8 show only the light emitting source 15 and the light-guide plates 4 and 5, and the dot pattern 27 disposed on the front surface 22 is omitted. That is, like the lighting devices 41 to 44 according to Embodiments 1 to 4 described above, the lighting device 45 according to Embodiment 5 includes the light emitting source 15, the light-guide plate 5, the protection cover 31 that protects the light-guide plate 5, the reflection sheet 32 that reflects light leaking from the light-guide plate 5, a control circuit, and the like in the housing 10.

The lighting device 45 according to Embodiment 5 is different from the lighting device 44 according to Embodiment 4 described above only in that the light-guide plate 5 is formed of a high-refractive-index material. Typically, polymethyl methacrylate (PMMA) having a refractive index of 1.49 or glass having a refractive index of 1.49 or the like is used as the material of the light-guide plate.

On the other hand, in the present embodiment, as the material of the light-guide plate 5, such as styrene acrylonitrile (As) having a refractive index of 1.56, polycarbonate (PC) having a refractive index of 1.59, polystyrene (PS) having a refractive index of 1.59, or a copolymer of PMMA and PS having a refractive index of 1.56, and the like, a high-refractive-index material having a refractive index of 1.50 or more is used.

As shown in FIG. 8, in a case where the incident angles are the same, the refraction angle of the light-guide plate 5 having a higher refractive index than the refraction angle of the light-guide plate 4 having a low-refractive-index becomes larger. Therefore, in order to maintain the same alignment angle characteristics of the surface luminance of the front surface 22 between the light-guide plate 5 having a high-refractive-index and the light-guide plate 4 having a low-refractive-index, at least a taper angle θ₃ of the main dots 24 in the light-guide plate 5 having a higher refractive index needs to be larger than the taper angle θ₁ of the main dots 24 in the light-guide plate 4 having a low-refractive-index. In addition, it is preferable that the taper angle θ₂ of the sub-dot 25 is also larger in the light-guide plate 5 having a higher refractive index than the light-guide plate 4 having a low-refractive-index.

Thus, when the size of the upper bottom surface of the main dot 24 is constant as the taper angle of the main dot 24 increases from θ₁ to θ₃, the size of the lower bottom surface of the main dot 24 decreases from d₁ to d₃. When viewed from a direction orthogonal to the front surface 22, the proportion of the inclined side surfaces of the main dots 24 and the sub-dots 25 occupying the front surface 22 of the light-guide plate 5 having a higher refractive index is lower than that of the inclined side surfaces of the main dots 24 and the sub-dots 25 occupying the front surface 22 of the light-guide plate 4 having a low-refractive-index. Therefore, the light-guide plate 5 having a high-refractive-index has a lower haze ratio than the light-guide plate 4 having a low-refractive-index. The same is true for the taper angle of the sub-dot 25.

Therefore, according to the lighting device using the light-guide plate 5, it is possible to secure higher transparency at the time of non-lighting than the lighting device using the light-guide plate 4.

### Embodiment 6

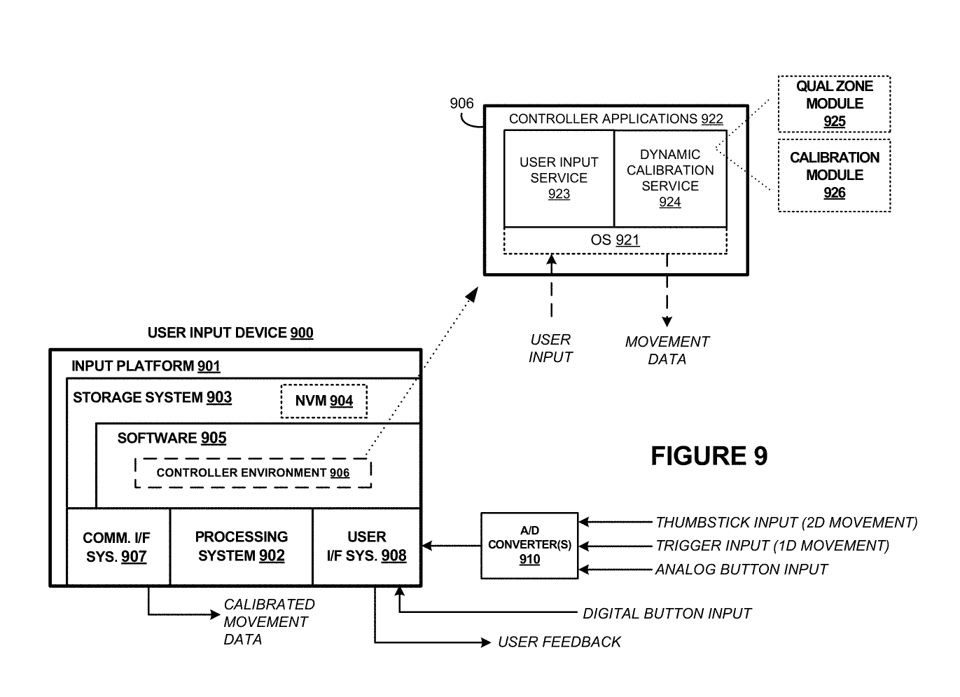

Another embodiment of the present invention will be described with reference to FIG. 9 as follows. For the convenience of explanation, members having the same functions as those described in the above embodiment are denoted by the same reference numerals, and description thereof is omitted.

FIG. 9 is a diagram for describing a light flux ϕemitted from a front surface 22 and a light flux ϕ₂ emitted from a rear surface 23 in a lighting device 46 using a light-guide plate 6 according to Embodiment 6. For simplicity, the lighting device 46 in FIG. 9 shows only the light emitting source 15 and the light-guide plate 6. That is, like the lighting devices 41 to 45 according to Embodiments 1 to 5 described above, the lighting device 46 according to Embodiment 6 includes the light emitting source 15, the light-guide plate 6, the protection cover 31 that protects the light-guide plate 6, the reflection sheet 32 that reflects light leaking from the light-guide plate 6, a control circuit, and the like in the housing 10.

The lighting device 46 according to Embodiment 6 is different from the lighting device 45 according to Embodiment 5 described above only in that a high-refractive-index coating 28 (high-refractive-index layer) is laminated on the rear surface 23 side of a base layer 20 of the light-guide plate 6.

A high-refractive-index coating 28 is only required to have a higher refractive index than the base layer 20 of the light-guide plate 6, and the rear surface 23 is coated with a film thickness of about 1 μm to 100 μm with, for example, one type of oxide such as titanium, aluminum, cerium, yttrium, zirconium, niobium, and antimony. In other words, the light-guide plate 6 includes the base layer 20 and the high-refractive-index coating 28 made of a material (second material) having a higher refractive index than the material (first material) constituting the base layer, and the base layer 20 has the front surface 22, and the high-refractive-index coating 26 has the rear surface 23 on the side surface opposite to the contact surface in contact with the base layer 20.

The high-refractive-index coating 28 is laminated on the rear surface 23 of the light-guide plate 6, and both the main dot 24 and the sub-dot 25 of the dot pattern 27 disposed concavely on the rear surface 23 are buried in the high-refractive-index coating 28. According to the computer simulation in which light is incident on the light-guide plate 6 from the end face 21, it is possible to reduce (smaller than 1) the light flux ratio ϕ₁/ϕ₂ of the light flux 4u emitted from the rear surface 23 with respect to the light flux ϕ₁ emitted from the front surface 22.

As described above, according to the light-guide plate 6, the rear surface 23 may be made brighter than the front surface 22.

### Embodiment 7

Another embodiment of the present invention will be described with reference to FIG. 10 as follows. For the convenience of explanation, members having the same functions as those described in the above embodiment are denoted by the same reference numerals, and description thereof is omitted.

FIG. 10 is a diagram for describing a light flux ϕ₁ emitted from a front surface 22 and a light flux ϕ₂ emitted from a rear surface 23 in a lighting device 47 using a light-guide plate 7 according to Embodiment 7. For simplicity, the lighting device 47 in FIG. 10 shows only the light emitting source 15 and the light-guide plate 7. That is, like the lighting devices 41 to 46 according to Embodiments 1 to 6 described above, the lighting device 47 according to Embodiment 7 includes the light emitting source 15, the light-guide plate 7, the protection cover 31 that protects the light-guide plate 7, the reflection sheet 32 that reflects light leaking from the light-guide plate 7, a control circuit, and the like in the housing 10.

The lighting device 47 according to Embodiment 7 is different from the lighting device 45 according to Embodiment 5 described above only in that the low-refractive-index coating 29 (low-refractive-index layer) is laminated on the front surface side of the base layer 20 of the light-guide plate 7. The low-refractive-index coating 29 is only required to have a lower-refractive-index than the main body of the light-guide plate 5, and the front surface of the base layer is coated with a film thickness of about 1 μm to 100 μm with, for example, a siloxane resin, fluorine resin, or the like. In other words, the light-guide plate 7 includes the base layer 20 and the low refractive-index coating 29 made of a material (third material) having a lower-refractive-index than the material (first material) constituting the base layer, and the base layer 20 has the rear surface 23, and the low-refractive-index coating 29 has the front surface 22 on the side surface opposite to the contact surface in contact with the base layer 20.

The low-refractive-index coating 29 is laminated on the front surface 22 of the light-guide plate 7, and both the main dot 24 and the sub-dot 25 of the dot pattern 27 disposed on the front surface 22 are buried in the low-refractive-index coating 29.

The end face 21 includes the end face of the base layer 20 and the end face of the low-refractive-index coating 29, and the light emitted from the light emitting source 15 is incident on both the base layer 20 and the low-refractive-index coating 29 from the end face 21. The light incident inside of the base layer 20 and the low-refractive-index coating 29 diffuses while striking the main dots 24 as well as the sub-dots 25 inside the base layer 20 and the low-refractive-index coating 29 respectively.

According to the computer simulation in which light is incident on the light-guide plate 7 from the end face 21, it is possible to increase (larger than 1) the light flux ratio ϕ₁/ϕ₂ of the light flux ϕ₂ emitted from the rear surface 23 with respect to the light flux ϕ₁ emitted from the front surface 22. Since the light flux ϕ₂ on the rear surface 23 is smaller than the light flux ϕ₁ on the front surface 22, in the lighting device 47, the reflection sheet 32 that reflects the light leaking from the rear surface 23 to the light-guide plate 7 may not be disposed between the rear surface 23 of the light-guide plate 7 and the rear chassis 12.

In addition, in a case where the lighting device including the light-guide plate 7 is used as a backlight of a transparent display, it is possible to provide a transparent display is which the rear surface 23 side of the light-guide plate 7 is dark.

### Embodiment 8

Another embodiment of the present invention will be described with reference to FIG. 11 as follows. For the convenience of explanation, members having the same functions as those described in the above embodiment are denoted by the same reference numerals, and description thereof is omitted.

FIG. 11 is a perspective diagram showing a schematic configuration of a lighting equipment 50 using a light-guide plate 7 according to Embodiment. (a) of FIG. 11 shows the lighting equipment 50 in which the light-guide plate 7 is rectangular, and (b) of FIG. 11 shows the lighting equipment 50 in which the light-guide plate 7 is donut shaped.

As shown in FIG. 11, the lighting equipment 50 includes a lighting device 48, a power supply unit 51 connected to an electrical wiring such as a house or a facility, and a cover 52 covering the power supply unit 51, a cable 53 for electrically connecting the lighting device 48 to the power supply unit 51, and a wire 54 for suspending the lighting device 48 from the ceiling of a house or a facility.

As the power supply unit 51, the cover 52, the cable 53, and the wire 54, known ones may be used and will not be described in detail in this specification.

The lighting device 48 is suspended directly on the wire 54 and includes the housing 10 that houses the light emitting source 15 therein, the light-guide plate 7 that is supported by the housing 10 and functions as a surface light source, and the protection cover 31 that protects the light-guide plate 7. The control circuit for driving and controlling the light emitting source 15 is mainly disposed in the power supply unit 51.

The material forming the light-guide plate 7 is PMMA, As, PC, PS, or a resin such as a copolymer of PMMA and PS, or glass. Therefore, since the light-guide plate 7 has sufficient mechanical strength to support the own weight thereof, the light-guide plate 7 may be supported like a cantilever only at the end portion like the lighting device 48. The light-guide plate 7 is installed in a direction in which the front surface 22 faces the floor and the rear surface 23 faces the ceiling.

The protection cover 31 is disposed on the front surface Z2 and the rear surface 23 of the light-guide plate 7 and the end face 21 that does not face the light emitting source 15. In addition, the surface of the light-guide plate 7 on which the protection cover 31 is not disposed is in the housing 10.

Since the front surface 22 side of the light-guide plate 7 is bright and the rear surface 23 side is dark, the floor may be efficiently illuminated.

The light-guide plate used for the lighting device 48 is described as being the light-guide plate 7 according to Embodiment 7 described above but may be any one of the light-guide plates 1 to 6 according to Embodiments 1 to 6 described above. In addition, the protection cover 31 is colorless and transparent but may be colored and transparent.

### Embodiment 9

Another embodiment of the present invention will be described with reference to FIG. 12 as follows. For the convenience of explanation, members having the same functions as those described in the above embodiment are denoted by the same reference numerals, and description thereof is omitted.

FIG. 12 is a partial cross-sectional diagram showing the liquid crystal display device 61 using the light-guide plate 7 according to Embodiment 9 of the present invention.

As shown in FIG. 12, the liquid crystal display device 61 includes the light emitting source 15 including the LED substrate 16 and the LEDs 17 mounted on the LED substrate 16, and the light-guide plate 7, an optical sheet 34 for adjusting the light distribution characteristic of light emitted in a planar shape from the front surface 22, the reflection sheet 32 that reflects light leaking from the light-guide plate 1, a liquid crystal panel 35, and a control circuit (not shown) for driving and controlling the light emitting source 15 and a liquid crystal panel 35, and the like in the housing 10 including the front chassis 11, the rear chassis 12, and the bezel 14. That is, the liquid crystal display device 61 includes the liquid crystal panel 35 and the lighting device 47.

The optical sheet 34 has a two-layer structure of a prism sheet disposed on the front surface 22 of the light-guide plate 7 and disposed in order from the side close to the front surface 22 for increasing the luminance when viewed from a direction orthogonal no the front surface 22, and a polarized light reflection sheet for increasing the luminance by deflective reflection.

In a light-guide plate of the related art, it was necessary to superimpose a diffusing sheet for reducing uneven light emission on a light outgoing surface. Therefore, in a liquid crystal display device using a light-guide plate of the related art, an optical sheet has at least a three-layer structure of a diffusing sheet or a lens sheet for eliminating uneven light emission caused by the light-guide plate, which is disposed in order from the side close to the light outgoing surface, a prism sheet or a lens sheet for increasing luminance when viewed from a direction orthogonal to the light outgoing surface, and a polarized light reflection sheet for increasing brightness by deflective reflection.

In contrast, in the liquid crystal display device 61 according to Embodiment 8 of the present invention, since uneven light emission occurring on the front surface 22 of the light-guide plate 7 is reduced, the optical sheet 34 may have a two-layer structure in which one diffusing sheet or lens sheet is reduced. In this way, it is possible to make the liquid crystal display device 61 thinner, lighter, and the like.

The liquid crystal panel 35 is a liquid crystal panel using a backlight, and since a known liquid crystal panel may be used and will not be described in detail in this specification.

The liquid crystal panel 35 is disposed apart from the front surface 22 of the light-guide plate 7 by the front chassis 11 so as to face the front surface 22 of the light-guide plate 7 with an air layer interposed between the optical sheets 34. The reflection sheet 32, the light-guide plate 7, the optical sheet 34, and the liquid crystal panel 35 are disposed so as to overlap the rear chassis 12 in this order and are fixed by the front chassis 11 and the bezel 14. When the light from the light-guide plate 7 transmits through the liquid crystal panel 35, the liquid crystal panel may display an image.

According to the liquid crystal display device 61, it is unnecessary to use a diffusing sheet which is necessary for the related art, and it is possible to prevent the occurrence of moire.

In the liquid crystal display device 61, the light-guide plates 1 to 6 may be used instead of the light-guide plate 7.

### Embodiment 10

Another embodiment of the present invention will be described with reference to FIG. 13 as follows. For the convenience of explanation, members having the same functions as those described in the above embodiment are denoted by the same reference numerals, and description thereof is omitted.

FIG. 13 is a partial cross-sectional diagram showing the liquid crystal display device 61 using the light-guide plate 7 according to Embodiment 10 of the present invention.

Like the liquid crystal display device 61 according to Embodiment 9 described above, the liquid crystal display device 62 according to Embodiment 10 includes the light emitting source 15, the light-guide plate 7, the liquid crystal panel 35, the control circuit, and the like in the housing 10 including the front chassis 11, the rear chassis 12, and the bezel 14. Unlike the liquid crystal display device 61 according to Embodiment 9 described above, in the liquid crystal display device 62 according to Embodiment 10, the rear chassis 12 is partially replaced with a transparent protection plate 36. The liquid crystal display device 62 is a transparent display.

The liquid crystal display device 62 according to

Embodiment 10 is different from the liquid crystal display device 61 according to Embodiment 9 described above only in that the reflection sheet 32 and the optical sheet 34 are not provided and the rear chassis 12 is partially formed as the transparent protection plate 36. Since the light-guide plate 7 according to the present invention has less uneven light emission, moire in the liquid crystal display device 62 may be sufficiently suppressed without providing the optical sheet 34.

The transparent protection plate 36 is disposed so that the region of the rear chassis 12 corresponding to the region of the liquid crystal panel 35 viewed from the housing 10 is replaced by the transparent protection plate 36. The transparent protection plate 36 is a protection plate that protects the rear surface 23 of the light-guide plate 7 and is capable of transmitting through the light emitted from the rear surface 23. The transparent protection plate 36 is disposed to face the rear surface 23 of the light-guide plate 7.

Since the light-guide plate 7 according to the present invention has a low haze ratio, the reflection sheet 32 and the optical sheet 34 are unnecessary. Therefore, external light incident on the transparent protection plate 36 from the rear surface 23 side of the liquid crystal display device 62 may transmit through the transparent protection plate 36, the light-guide plate 7, and the liquid crystal panel 35 and reach the front surface 22 side of the liquid crystal display device 62. Therefore, when a user views the liquid crystal panel 35 from the front surface 22 side of the liquid crystal display device 62, the user may see the image displayed on the liquid crystal panel 35 and the scenery on the rear surface 23 side of the liquid crystal display device 62 through the liquid crystal display device 62.

Similarly, the light coming from the front surface 22 side of the liquid crystal display device 62 may transmit through the liquid crystal panel 35, the light-guide plate 7 and the transparent protection plate 36 and reach the rear surface 23 side of the liquid crystal display device 62. Therefore, when the user views the transparent protection plate 36 from the rear surface 23 side of the liquid crystal display device 62, the user may see the image displayed on the liquid crystal panel 35 and the scenery on the front surface 22 side of the liquid crystal display device 62 through the liquid crystal display device 62.

According to the liquid crystal display device 62, it is possible to obtain a transparent display which is transparent and free from moire. In the liquid crystal display device 62, the light-guide plates 1 to 6 may be used instead of the light-guide plate 7.

### Embodiment 11

Another embodiment of the present invention will be described with reference to FIG. 14 as follows. For the convenience of explanation, members having the same functions as those described in the above embodiment are denoted by the same reference numerals, and description thereof is omitted.

FIG. 14 is a partial cross-sectional diagram showing the liquid crystal display device 61 using the light-guide plate 7 according to Embodiment 11 of the present invention.

Like the liquid crystal display device 62 according to Embodiment 10 described above, the liquid crystal display device 63 according to Embodiment 11 includes the light emitting source 15, the light-guide plate 7, the liquid crystal panel 35, the control circuit, and the like in the housing 10 including the front chassis 11, the rear chassis 12 partially replaced by the transparent protection plate 36, and the bezel 14. Unlike the liquid crystal display device 62 according to Embodiment 10 described above, the liquid crystal display device 63 according to Embodiment 11 includes a reflective polarizing sheet 37 (polarized light reflection sheet) between the rear chassis 12 and the light-guide plate 7.

Like the reflection sheet 32, the reflective polarizing sheet 37 is disposed between the rear chassis 12 (in particular, the transparent protection plate 36) and the rear surface 23 of the light-guide plate 7 so as to face the rear surface 23 of the light-guide plate 7 with an air layer interposed therebetween. The reflective polarizing sheet 37, the light-guide plate 7, and the liquid crystal panel 35 are disposed so as to overlap the rear chassis 12 in this order and are fixed by the front chassis 11 and the bezel 14.

The liquid crystal display device 63 according to Embodiment 11 is different from the liquid crystal display device 62 according to Embodiment 10 described above only in that the reflective polarizing sheet 37 is provided.

The reflective polarization axis of the reflective polarizing sheet 37 is in the same direction as the transmission polarization axis of the liquid crystal panel 35. Specifically, the liquid crystal and 35 transmits P-polarized light and absorbs S-polarized light whose polarization direction is orthogonal to P-polarized light. Then, the reflective polarizing sheet 37 reflects P-polarized light and transmits S-polarized light.

For example, even if the P-polarized light out of the light emitted from the light emitting source 15 leaks from the rear surface 23 of the light-guide plate 7, since the P-polarize light is reflected by the reflective polarizing sheet 37, as a result, all of the P-polarized light emitted from the light emitting source 15 is incident on the liquid crystal panel 35 from the front surface 22 of the light-guide plate 7. In contrast, in the liquid crystal display device 62 according to Embodiment 10 described above in which the reflective polarizing sheet 37 is not disposed, when P-polarized light emitted from the light emitting source 15 leaks from the rear surface 23 of the light-guide plate 7, the P-polarized light transmit through the transparent protection plate 36 as it is. Therefore, when viewed the liquid crystal display device 63 from the liquid crystal panel 35 side, the luminance of the display screen of the liquid crystal display device 62 is increased.

Further, for example, S-polarized light out of external light from the transparent protection plate 36 side transmits through the reflective polarizing sheet 37 but is almost absorbed by the liquid crystal panel 35. Out of the external light from the transparent protection plate 36 side, P-polarized light is reflected by the reflective polarizing sheet 37. Therefore, when viewed the liquid crystal display device 63 from the transparent protection plate 36 side, the liquid crystal display device 63 looks like a half mirror.

As described above, the liquid crystal display device 63 may increase the luminance of the liquid crystal display device 62 from the liquid crystal panel 35 side while maintaining transparency by providing the reflective polarizing sheet 37 between the rear surface 23 of the light-guide plate 7 and the transparent protection plate 36.

[Summary]

The light-guide plate according to Aspect 1 of the present invention is a surface different from an end face as a light incident surface, including a first main surface and a second main surface that faces to each other, in which a dot pattern including first type dots and second type dots which are structures having different shapes from each other is disposed on the second main surface.

According to the above configuration, the dot pattern includes first type dots and second type dots which are structures having different shapes. For this reason, the reflection and refraction by the dot, pattern become complicated as compared with the reflection and refraction by a dot pattern in which dots having one kind of shape are disposed, and since the light is sufficiently diffused in the light guide, uneven light emission of the light-guide plate is reduced.

Therefore, even if there is no diffusing optical sheet disposed on the main surface of the light-guide plate having a dot pattern in which the dots having one kind of shape of the related art are disposed, it as possible to provide a light-guide plate in which light diffusion and uneven light emission are sufficiently reduced.

The light-guide plate according to Aspect 2 of the present invention may be configured such that the first type dot and the second type dot is in the shape of a cone or pyramid, respectively, and the angles formed by the lower bottom surface and the inclined side surface are different from each other in Aspect 1 described above.

According to the above configuration, the angle between the lower bottom surface and the inclined side surface is different between the first type dots and the second type dots. Therefore, the reflection direction and the refraction direction by the first type dots are different from the reflection direction and the refraction direction by the second type dots. In this way, reflection and refraction due to the dot pattern become complicated, and the uneven light emission of the light-guide plate is reduced.

In addition, in a case where the shape of at least one of the first type dot and the second type dot is a pyramid, when viewed from a direction orthogonal to the first main surface and the second main surface, the upper bottom surface looks transparent rather than the inclined side surface, and therefore the haze ratio of the light-guide plate is reduced. In this way, it is possible to obtain a transparent light-guide plate.

The light-guide plate according to Aspect 3 of the present invention may be configured such that at least one of the first type dot and the second type dot is a pyramid with the upper bottom surface and the lower bottom surface are parallel to each other in Aspect 1 or 2 described above.

According to the above configuration, the shape of at least one of the first type dot and the second type dot is a pyramid with the upper bottom surface and the lower bottom surface parallel to each other. Since the upper bottom surface and the lower bottom surface are parallel to each other, when viewed from a direction orthogonal to the first main surface and the second main surface, a portion of the upper bottom surface of the truncated cone looks more transparent than the case where the upper bottom surface and the lower bottom surface are not parallel. Therefore, it is possible to reduce the haze ratio of the light-guide plate and to enhance the transparency of the light-guide plate. In this way, it is possible to ensure both transparency and diffusion effects.

The light-guide plate according to Aspect 4 of the present invention may be configured such that the shape of at least one of the first type dot and the second type dot is a cone body or a truncated cone in Aspect 2 or 3.

According to the above configuration, the shape of at least one of the first type dot and the second type dot is a cone body or a truncated cone. Therefore, it is possible to prevent the diffraction effect from occurring and to further enhance the diffusion effect of the light-guide plate.

The light-guide plate according to Aspect 5 of the present invention may be configured such that the dot pattern is also disposed on the first main surface in any one of Aspects 1 to 4 described above.

According to the above configuration, the dot pattern is disposed on both the first main surface and the second main surface. Therefore, the luminance distribution and the alignment angle characteristic of the surface luminance of the first main surface and the second main surface are equal.

The light-guide plate according to Aspect 6 of the present invention may be configured such that the dot pattern disposed on the first main surface and the dot pattern disposed on the second main surface are plane-symmetric in Aspect 5 described above.

According to the above configuration, the dot patterns are disposed plane-symmetrically on the first main surface and the second main surface. In this way, when viewed from a direction orthogonal to the first main surface and the second main surface, the dot patterns appear to overlap. Therefore, the proportion of the dot pattern occupying the first main surface or the second main surface of the light-guide plate is equivalent to that in the case where the dot pattern is disposed only on the first main surface. In this way, it is possible to dispose the dot pattern on both the first main surface and the second main surface while maintaining the haze ratio. For this reason, it is possible to diffuse and emit the light and emit while securing the transparency of the light-guide plate.

The light-guide plate according to Aspect 7 of the present invention may be configured such that the first type dots and the second type dots are recessed from the surface of the light-guide plate in any one of Aspects 1 to 6 described above.

According to the above configuration, the first type dots and the second type dots are recessed concavely from the surface of the light-guide plate. Therefore, it is possible to prevent the first type dots and the second type dots from disappearing from the surface of the light-guide plate by friction or rubbing. In addition, the light traveling inside the light-guide plate easily strikes the first type dots and the second type dots, and the number of times of reflection and refraction from when the light is incident on the end face until the light is emitted from the first main surface or the second main surface increases. For this reason, uneven light emission of the light-guide plate is reduced.

The light-guide plate according to Aspect 8 of the present invention may be configured such that the first type dots and the second type dots have a convex shape protruding from the surface of the light-guide plate in any one of Aspects 1 to 6 described above.

The light-guide plate according to Aspect 9 of the present invention may be configured to include a base layer made of the first material and having the first main surface in Aspect 7 or 8, and a high-refractive-index layer laminated on the base layer, made of the second material having a refractive index higher than that of the first material, and has a side surface opposite to the contact surface with the base layer being the second main surface.

According to the above configuration, a high-refractive-index layer is laminated on the second main surface side. In this way, it is possible to reduce the light flux ratio ϕ₁/ϕ₂ (smaller than 1) of the light flux ϕ₂ emitted from the second main surface to the light flux ϕ₁ emitted from the first main surface. In this way, it is possible to obtain a light-guide plate whose second main surface is brighter than the first main surface.

The light-guide plate according to Aspect 10 of the present invention may be configured to include a base layer made of the first material and having the second main surface in Aspect 7 or 8, and a low-refractive-index layer laminated on the base layer, made of the third material having a refractive index lower than that of the first material, and has a side surface opposite to the contact surface with the base layer being the first main surface.

According to the above configuration, a low-refractive-index layer is laminated on the first main surface side. In this way, it is possible to increase the light flux ratio ϕ₁/ϕ₂ (larger than 1) of the light flux ϕ₂ emitted from the second main surface to the light fluxϕ₁ emitted from the first main surface. In this way, it is possible to obtain a light-guide plate whose first main surface is brighter than the second main surface.

The lighting device according to Aspect 11 of the present invention may be configured to include the light-guide plate according to any one of Aspects 1 to 10 described above and a light source that is disposed to face the end face of the light-guide plate and that emits the light.

According to the above configuration, it is possible to realize a surface emitting lighting device with less uneven light emission.

The display device according to Aspect 12 of the present invention may be configured to include the lighting device according to Aspect 11 described above and a liquid crystal panel disposed to face the first main surface.

According to the above configuration, it is possible to realize a display device using a surface emitting lighting device with less uneven light emission as a backlight.

The display device according to Aspect 13 of the present invention may be configured to include the reflection sheet disposed opposite to the second main surface in Aspect 12 described above.

According to the above configuration, the reflection sheet is disposed so as to face the liquid crystal panel with the light-guide plate interposed therebetween and reflects the light leaking from the second main surface to the light-guide plate. Therefore, the amount of light incident on the liquid crystal panel from the light-guide plate increases, and it is possible to increase the display luminance of the display device.

The display device according to Aspect 14 of the present invention may be configured to include the protection plate that protects the second main surface and transmits the light emitted from the second main surface in Aspect 12 described above.

According to the above configuration, the liquid crystal panel, the light-guide plate, and the protection plate may transmit light. Therefore, it is possible to realize a display device which is a transparent display in which the user may see the opposite side of the display device through the display device.

The display device according to Aspect 15 of the present invention may be configured to include the polarized light reflection sheet that is disposed between the second main surface and the protection plate and reflects light, in a polarization direction, which may be transmitted through the liquid crystal panel in Aspect 14 described above.

According to the above configuration, the polarized light reflection sheet reflects the light, in the polarization direction leaking from the second main surface, which may be transmitted through the liquid crystal panel to the light-guide plane. Therefore, it is possible to increase the display luminance of the display device while maintaining transparency as a transparent display.

The present invention is not limited to the above-described embodiments, but various modifications are possible within the scope indicated in the claims, and embodiments obtained by appropriately combining technical means disclosed in different embodiments are also included in the technical scope of the present invention. Further, it is possible to form new technical features by combining technical means disclosed in each embodiment.

### REFERENCE SIGNS LIST

1 to 7 light-guide plate

10 housing

11 front chassis

12 rear chassis

14 bezel

15 light emitting source (light source)

16 LED substrate

17 LED (light source)

18 optical axis direction

19 normal direction

20 base layer

21 end face

22 front surface (first main surface)

23 rear surface (second main surface)

24 main dot (first type dot)

25 sub-dot (second type dot)

26, 27 dot pattern

28 high-refractive-index coating (high-refractive-index layer)

29 low-refractive-index coating (low-refractive-index layer)

31 protection cover

32 reflection sheet

34 optical sheet

35 liquid crystal panel

36 transparent protection plate (protection plate)

37 reflective polarizing sheet (polarized light reflection sheet)

41˜48 lighting device

50 lighting equipment

51 power supply unit

52 cover

53 cable

54 wire

61 to 63 liquid crystal display device (display device)

g1, g2 alignment angle characteristics

ϕ₁, ϕ₂ light flux

θ₁, θ₂ taper angle (angles formed by lower bottom surface and inclined side surface)

1. A light-guide plate comprising:
a first main surface; and
a second main surface,
wherein the first main surface and the second main surface are surfaces different from an end face of light incident surface and face each other, and
a dot pattern including a first type dot and a second type dot which are structures having different shapes from each other is disposed on the second main surface.

2. The light-guide plate according to claim 1,
wherein, in the first type dot and the second type dot, each shape is a cone or a truncated cone, and angles formed by a lower bottom surface and an inclined side surface are different from each other.

3. The light-guide plate according to claim 1,
wherein the shape of at least one of the first type dot and the second type dot is a truncated cone with an upper bottom surface and a lower bottom surface parallel to each other.

4. The light-guide plate according to claim 1,
wherein the shape of at least one of the first type dot and the second type dot is a circular cone or a truncated circular cone.

5. The light-guide plate according to claim 1,
wherein the dot pattern is also disposed on the first main surface.

6. The light-guide plate according to claim 5,
wherein the dot pattern disposed on the first main surface and the dot pattern disposed on the second main surface are plane-symmetric.

7. The light-guide plate according to claim 1,
wherein the first type dot and the second type dot are recessed from a surface of the light-guide plate.

8. The light-guide plate according to claim 1,
wherein the first type dot and the second type dot are in convex shapes protruding from a surface of the light-guide plate.

9. The light-guide plate according to claim 7, further comprising:
a base layer made of a first material and having the first main surface; and
a high-refractive-index layer laminated on the base layer and made of a second material having a refractive index higher than that of the first material, and having a surface opposite to a contact surface with the base layer being the second main surface.

10. The light-guide plate according to claim 7, further comprising:
a base layer made of a first material and having the second main surface; and
a low-refractive-index layer laminated on the base layer and made of a third material having a refractive index lower than that of the first material, and having a surface opposite to a contact surface with the base layer being the first main surface.

11. A lighting device comprising:
The light-guide plate according to claim 1; and
a light source that is disposed to face the end face of the light-guide plate and emits the light.

12. A display device comprising:
the lighting device according to claim 11; and
a liquid crystal panel that is disposed to face the first main surface.

13. The display device according to claim 12, further comprising:
a reflection sheet that is disposed to face the second main surface.

14. The display device according to claim 12, further comprising:
a protection plate that protects the second main surface and transmits the light emitted from the second main surface.

15. The display device according to claim 14, further comprising:
a polarized light reflection sheet that is disposed between the second main surface and the protection plate and reflects light, in a polarization direction, which is transmitted through the liquid crystal panel.
